(19) United States
(12) Patent Application Publication
(10) Pub. No.: US 2026/0050307 A1
(43) Pub. Date: Feb. 19, 2026

(54) INTEGRATED CIRCUIT PERFORMING DYNAMIC VOLTAGE AND FREQUENCY SCALING OPERATION AND METHOD OF OPERATING THE SAME

(71) Applicant: SAMSUNG ELECTRONICS CO., LTD., Suwon-si (KR)

(72) Inventors: Kyungmin Park, Suwon-si (KR); Inhwan Baek, Suwon-si (KR)

(21) Appl. No.: 19/200,392

(22) Filed: May 6, 2025

(30) Foreign Application Priority Data
Aug. 19, 2024 (KR) 10-2024-0110586

(51) Int. Cl. G06F 1/26

(52) U.S. Cl. CPC G06F 1/26

(57) ABSTRACT

Integrated circuits are provided. In one aspect, an integrated circuit includes a plurality of intellectual property (IP) blocks; a memory configured to store a dynamic voltage and frequency scaling (DVFS) table in which operating voltages and operating frequencies are classified into a plurality of groups based on power characteristics of the plurality of IP blocks, where the operating voltages and the operating frequencies correspond to utilizations; and a DVFS controller configured to calculate the workload of each of the plurality of IP blocks and control, based on the calculated workload and the DVFS table, the operating frequency provided to each of the plurality of IP blocks. The DVFS controller is configured to change the operating frequency of an IP block of the plurality of IP blocks based on the power characteristics of IP block before a utilization reaches a threshold utilization.

### CROSS-REFERENCE TO RELATED APPLICATION

This application is based on and claims priority under 35 U.S.C. § 119 to Korean Patent Application No. 10-2024-0110586, filed on Aug. 19, 2024, in the Korean Intellectual Property Office, the disclosure of which is incorporated by reference herein in its entirety.

### BACKGROUND

As integrated circuit technology is advanced and integration is intensified, the importance of power management of integrated circuits or devices including integrated circuits is increasing. In particular, power consumption may affect the temperature of integrated circuits, and the performance degradation of integrated circuits due to heat generation may be fatal.

Meanwhile, as intellectual property (IP) blocks (e.g., chips) included in an integrated circuit increase, the complexity of power management is increasing. Therefore, technology capable of efficiently managing the power of various IP blocks is desired. For power management, the dynamic voltage and frequency scaling (DVFS) operation of controlling an operating voltage and an operating frequency may be performed.

### SUMMARY

The present disclosure provides an integrated circuit that more efficiently performs a DVFS operation considering characteristics of IP blocks (or chips) and a method of operating the integrated circuit.

According to an aspect of the inventive concept, an integrated circuit is provided, including: a plurality of IP blocks; a memory configured to store a DVFS table in which operating voltages and operating frequencies are classified into a plurality of groups based on power characteristics of the plurality of IP blocks, where the operating voltages and the operating frequencies correspond to workloads; and a DVFS controller configured to calculate the workload of each of the plurality of IP blocks and control, based on the DVFS table and the calculated workload, the operating frequency provided to each of the plurality of IP blocks, where the DVFS controller is configured to change the operating frequency based on the power characteristics before a utilization reaches a threshold utilization, where the utilization is a ratio at which the IP block uses a clock signal having the operating frequency.

According to another aspect of the inventive concept, a method of operating an integrated circuit is provided, including: calculating a workload of each of a plurality of IP blocks, providing an operating frequency to each of the plurality of IP blocks based on the calculated workload and a DVFS table in which operating voltages and operating frequencies are classified into a plurality of groups based on power characteristics of the plurality of IP blocks, and changing the operating frequency based on the power characteristics before a utilization reaches a threshold utilization, wherein the utilization is a ratio at which the IP block uses a clock signal having the operating frequency.

According to another aspect of the inventive concept, an integrated circuit is provided, including: a plurality of IP blocks, a memory configured to store a DVFS table in which operating voltages and operating frequencies are classified into a plurality of groups based on power characteristics of the plurality of IP blocks, where the operating voltages and the operating frequencies correspond to workloads, a DVFS controller configured to calculate the workload of each of the IP blocks and generate, based on the calculated workload and the DVFS table, a voltage control signal and a frequency control signal for respectively controlling the operating voltage and the operating frequency that are provided to each of the IP blocks, a power management unit (PMU) configured to adjust a magnitude of a power voltage provided to each of the plurality of IP blocks in response to the voltage control signal, and a clock management unit (CMU) configured to adjust a frequency of a clock signal provided to each of the plurality of IP blocks in response to the frequency control signal, where the DVFS controller is configured to change the operating frequency based on the power characteristics before a utilization reaches a threshold utilization, wherein the utilization is a ratio at which the IP block uses a clock signal having the operating frequency.

### BRIEF DESCRIPTION OF THE DRAWINGS

Implementations will be more clearly understood from the following detailed description taken in conjunction with the accompanying drawings in which:

FIG. 1 is a block diagram illustrating an example of an integrated circuit according to an implementation;

FIG. 2 is a block diagram for describing an example of a dynamic voltage and frequency scaling (DVFS) operation according to an implementation;

FIG. 3 is a diagram for describing an example of a DVFS table according to an implementation;

FIG. 4 is a diagram for describing an example of a DVFS operation according to an implementation;

FIG. 5 is a diagram for describing an example of a DVFS operation according to an implementation;

FIG. 6 is a diagram for describing an example of a DVFS operation according to an implementation;

FIG. 7 is a block diagram for describing an example of update of a DVFS table according to an implementation;

FIG. 8 is a flowchart illustrating an example of a method of operating an integrated circuit, according to an implementation;

FIG. 9 is a flowchart illustrating an example of a method of operating an integrated circuit, according to an implementation;

FIG. 10 is a flowchart illustrating an example of a method of updating a DVFS table, according to an implementation;

FIG. 11 is a block diagram illustrating an example of a system according to an implementation; and

FIG. 12 is a block diagram illustrating an example of a communication device including an application processor (AP) according to an implementation.

### DETAILED DESCRIPTION OF THE EMBODIMENTS

Hereinafter, implementations of the present disclosure will be described in detail with reference to the accompanying drawings.

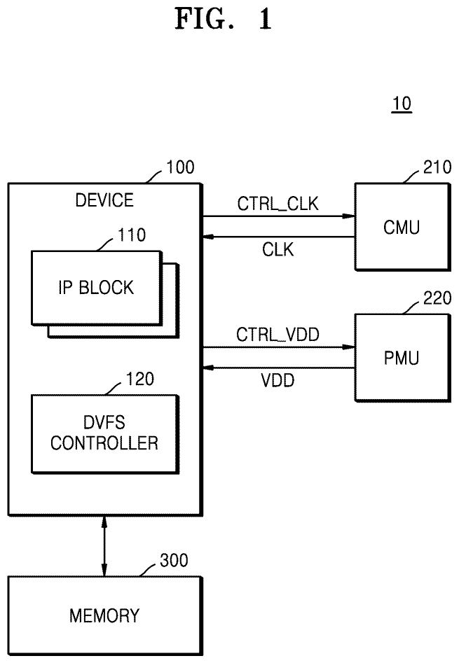

FIG. 1 is a block diagram illustrating an integrated circuit 10 according to an implementation.

Referring to FIG. 1, the integrated circuit 10 may include a device 100, a clock management unit (CMU) 210, a power management unit (PMU) 220, and a memory 300. In some implementations, at least some of the device 100, the CMU 210, the PMU 220, and the memory 300 may be included in one semiconductor package. In some implementations, the device 100, the CMU 210, the PMU 220, and the memory 300 may be included in one chip, that is, a system-on-chip (SoC), and the integrated circuit 10 may be referred to as an application processor (AP). The integrated circuit 10 may include a system bus (not shown) to which a protocol having a predetermined standard bus specification is applied, and may include various intellectual properties (IPs) connected to the system bus. As a standard specification for the system bus, the Advanced Microcontroller Bus Architecture (AMBA) protocol of Advanced RISC Machine (ARM) Ltd. may be applied. Bus types of the AMBA protocol may include Advanced High-Performance Bus (AHB), Advanced Peripheral Bus (APB), Advanced eXtensible Interface (AXI), AXI4, AXI Coherency Extensions (ACE), etc. In addition, other types of protocols such as uNetwork of Sonics Inc., CoreConnect of IBM, Open Core Protocol of OCP-IP, etc. may be applied.

The integrated circuit 10 may be a stationary computing system such as a desktop personal computer (PC), a server, etc., and may correspond to a laptop computer, a mobile phone, a smartphone, a tablet PC, a personal digital assistant (PDA), an enterprise digital assistant (EDA), a digital still camera, a digital video camera, a digital multimedia player (PMP), a personal navigation device or a portable navigation device (PND), a handheld game console, a mobile Internet device (MID), a wearable computer, an Internet of Things (IoT) device, an Internet of Everything (IoE) device, or an e-book.

The device 100 may include a plurality of IP blocks 110 and a dynamic voltage and frequency scaling (DVFS) controller 120. The device 100 may control the integrated circuit 10, and may be referred to as a processor, a host processor, a host device, etc. In some implementations, the device 100 may include the plurality of IP blocks 110 executing a series of instructions, and may execute a program consisting of instructions. The program may include a plurality of subprograms, and the subprogram may be referred to as a subroutine, a routine, a procedure, a function, etc. In some implementations, the device 100 may be designed as an integrated circuit implemented as a plurality of transistors. The device 100 may include, for example, a central processing unit (CPU), a graphics processing unit (GPU), a neural processing unit (NPU), or an image signal processor (ISP). Meanwhile, FIG. 1 illustrates one device 100, but the type and number of devices 100 included in the integrated circuit 10 are not limited thereto. In some implementations, the DVFS controller 120 may be located outside the device 100.

Each of the plurality of IP blocks 110 may independently process an instruction. Each of the plurality of IP blocks 110 may be a CPU core, a GPU core, an NPU core, or an ISP core. Because a plurality of cores are included in the device 100, the integrated circuit 10 may be referred to as a multi-core processor. The IP block 110 may be referred to as a sub-function block.

Each of the plurality of IP blocks 110 may process an instruction according to a clock signal CLK and a power supply voltage VDD (or voltage-frequency level). Performance of each IP block 110 may depend on the clock signal CLK and the power supply voltage VDD. As the magnitude of the power supply voltage VDD and the frequency of the clock signal CLK provided to the IP block 110 increases, the performance of the device 100 may be improved, and power consumption may increase.

However, in some implementations, some of the IP blocks 110 may reduce power consumption even when the frequency of the clock signal CLK increases according to power characteristics (or chip characteristics) (e.g., dynamic power and/or static power). The integrated circuit 10 according to an implementation may perform the DVFS operation based on the power characteristics. DVFS operation control according to the power characteristics of the IP blocks 110 (or chips) will be described in detail with reference to the drawings to be described below. For convenience of description, herein, the frequency of the clock signal CLK may be referred to as an operating frequency, and the magnitude of the power supply voltage VDD may be referred to as an operating voltage.

The DVFS controller 120 may provide, to the CMU 210 and/or the PMU 220, control signals CTRL_CLK and CTRL_VDD for adjusting an operating frequency and/or an operating voltage of each of function blocks according to an operating state of each of various function blocks (e.g., the IP blocks 110) in the integrated circuit 10. In an implementation, the DVFS controller 120 may adjust the operating frequency and the operating voltage provided to each of the plurality of IP blocks 110. In some implementations, the DVFS controller 120 may provide the operating voltage and the operating frequency provided to each of the plurality of IP blocks 110 by controlling the CMU 210 and/or the PMU 220 based on the power characteristic (e.g., dynamic power and/or static power) of each of the plurality of IP blocks 110. For example, the DVFS controller 120 may output the control signals CTRL_CLK and CTRL_VDD for controlling operating conditions of each of the plurality of IP blocks 110 every predetermined sample period.

The CMU 210 may generate the clock signal CLK and adjust a frequency of the clock signal CLK, based on the clock control signal CTRL_CLK. For example, the CMU 210 may include an oscillator that generates the clock signal CLK based on the clock control signal CTRL_CLK. The CMU 210 may be referred to as a clock generator or a clock generation circuit. The operating frequency may refer to a basic frequency of a system clock provided by the CMU 210 to the IP block 110.

The PMU 220 may generate the power voltage VDD and adjust the magnitude of the power voltage VDD, based on the power voltage control signal CTRL_VDD. In an implementation, the PMU 220 may include a switching regulator that generates the power voltage VDD based on the power voltage control signal CTRL_VDD, and may include a power management integrated circuit (PMIC).

The memory 300 may be accessed by the device 100, and the device 100 may store data in the memory 300 or read data stored in the memory 300. The memory 300 may include a volatile memory device such as static random access memory (SRAM), dynamic random access memory (DRAM), etc., and may include a non-volatile memory device such as flash memory, resistive random access memory (RRAM), etc.

In some implementations, the memory 300 may store a DVFS table for reference when the DVFS controller 120 performs the DVFS operation. More specifically, the DVFS controller 120 may calculate a workload of work performed by the integrated circuit 10 and/or the plurality of IP blocks 110, and may refer to the DVFS table stored in the memory 300 to perform the DVFS operation in response to the calculated workload. The DVFS controller 120 may obtain the operating voltage and/or the operating frequency to be provided to the IP block 110 in the corresponding workload from the DVFS table.

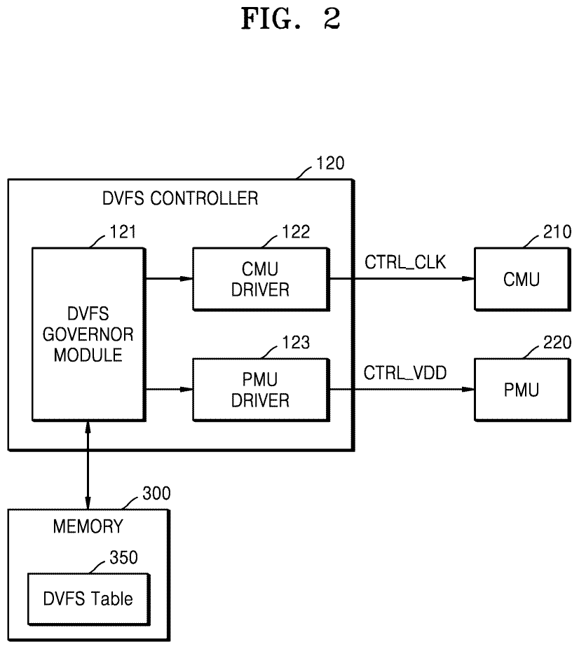

In some implementations, the DVFS table may include a plurality of groups classified according to the power characteristics of the IP blocks 110 (or chips). That is, the DVFS controller 120 may perform a more efficient DVFS operation by referring to the DVFS table to which the power characteristics (e.g., dynamic power consumption or static power consumption) of the IP blocks 110 are reflected. In some implementations, the DVFS controller 120 may provide the operating frequency to the IP blocks 110, based on the DVFS table, and some of the IP blocks 110 may reduce power consumption, even when the operating frequency increases according to the power characteristics. In some implementations, as the workload of the IP blocks 110 increases or decreases, a utilization may fluctuate, and even when the changed utilization does not reach a threshold utilization for changing the operating frequency, a margin may be secured in terms of timing for previously changing the operating frequency, thereby reducing power consumption. As described above, the integrated circuit 10 according to an implementation may more efficiently manage power by performing the DVFS operation according to the corresponding power characteristic of each IP block 110, thereby reducing heat generation of the integrated circuit 10 and/or the device 100 and improving performance thereof. A detailed description in this regard will be given below with reference to FIGS. 2 to 6.

The integrated circuit 10 may further include components other than those illustrated in FIG. 1. For example, the integrated circuit 10 may further include other types of function blocks such as an input/output (I/O) interface block, a universal serial bus (USB) host block, a USB slave block, etc.

FIG. 2 is a block diagram for describing a DVFS operation according to an implementation.

Referring to FIG. 2, the DVFS controller 120 may include a DVFS governor module 121, a CMU driver 122, and a PMU driver 123. Hereinafter, a module may refer to hardware capable of performing functions and operations according to respective names or computer program code capable of performing a specific function and operation. However, the present disclosure is not limited thereto, and may refer to an electronic recording medium equipped with the computer program code capable of performing the specific function and operation, for example, a processor. That is, the module may refer to a functional and/or structural combination of hardware performing the present disclosure and/or software driving the hardware.

The DVFS governor module 121 may control the overall DVFS operations. The DVFS governor module 121 may control the CMU driver 122 and the PMU driver 123 based on the determined operating voltage and/or operating frequency. In some implementations, the DVFS governor module 121 may refer to a DVFS table 350 stored in the memory 300 and classified according to the power characteristics of IP blocks, and may control the CMU driver 122 and the PMU driver 123 to adjust the operating voltage and the operating frequency (e.g., voltage-frequency level) provided to the IP blocks, based on the referenced DVFS table 350.

The CMU driver 122 may output the clock control signal CTRL_CLK to the CMU 210 by the control of the DVFS governor module 121. The CMU 210 may provide the clock signal CLK having an operating frequency determined according to the clock control signal CTRL_CLK to the device 100 and/or the plurality of IP blocks 110. The PMU driver 123 may output the power control signal CTRL_VDD to the PMU 220 by the control of the DVFS governor module 121. The PMU 220 may provide the power voltage VDD having a magnitude determined according to the power control signal CTRL_VDD to the device 100 and/or the plurality of IP blocks 110.

The memory 300 may include the DVFS table 350. The DVFS table 350 may include a plurality of operating voltages and operating frequencies (a plurality of voltage-frequency levels). The plurality of operating voltages and operating frequencies included in the DVFS table 350 may be classified into a plurality of groups according to the power characteristics of the IP blocks. In some implementation, the single DVFS table 350 is illustrated in FIG. 2., but a plurality of DVFS tables 350 may be included. For example, the plurality of DVFS tables 350 may be generated according to an environmental change of the integrated circuit 10 (e.g., a change in the characteristics of the IP blocks). In this regard, the DVFS governor module 121 may perform the DVFS operation according to an implementation by selecting any one of the plurality of DVFS tables 350 generated according to the environment.

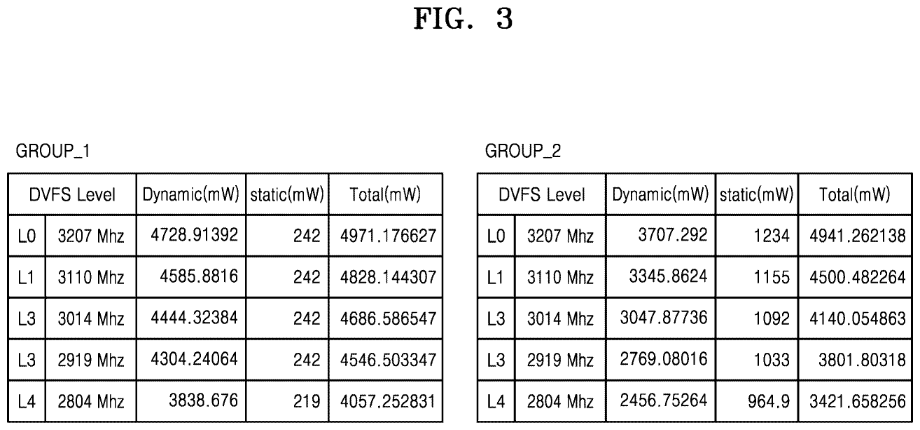

FIG. 3 is a diagram for describing a DVFS table according to an implementation.

Referring to FIG. 3, a plurality of groups included in the DVFS table 350 may include a first group GROUP_1 and a second group GROUP_2. In FIG. 3, only some of a plurality of operating frequencies are illustrated.

In some implementations, the first group GROUP_1 and the second group GROUP_2 may be grouped according to a power characteristic, and the power characteristic may include information about dynamic power consumption and/or static power consumption of an IP block. That is, as shown, the first group GROUP_1 and the second group GROUP_2 may be classified according to power consumed in response to an operating frequency. More specifically, the first group GROUP_1 may be a group exhibiting characteristics of relatively high dynamic power consumption and relatively low static power consumption, whereas the second group GROUP_2 may be a group exhibiting characteristics of relatively low dynamic power consumption and relatively high static power consumption. Some of the plurality of IP blocks 110 may belong to the first group GROUP_1 according to power characteristics (e.g., features with low static power consumption), and the other IP blocks 110 may belong to the second group GROUP_2 according to power characteristics (e.g., features with low dynamic power consumption).

The DVFS table 350 may include a larger number of groups. That is, classification according to dynamic power consumption and/or static power consumption may be further refined. For example, the DVFS table 350 may consist of a plurality of groups (e.g., 9 groups) including the first group GROUP_1 and the second group GROUP_2, and each of the plurality of IP blocks 110 may belong to any one of the plurality of groups. In some implementations, the first group GROUP_1 may exhibit a characteristic having the lowest static power consumption, and the second group GROUP_2 may exhibit a characteristic having the lowest dynamic power consumption.

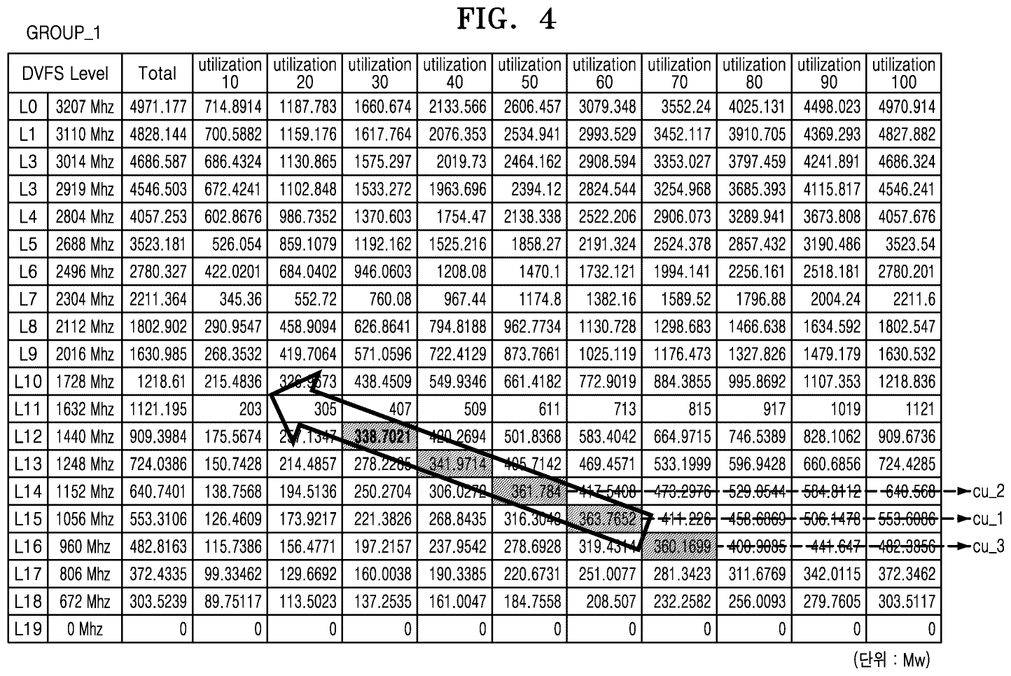

FIG. 4 is a diagram for describing an example of a DVFS operation according to an implementation.

Referring to FIG. 4, for example, the first group GROUP_1 included in the DVFS table 350 may show power consumption according to operating frequencies and utilizations (or workload) as shown. The utilization may mean a ratio of the total cycle counts of the clock signal CLK and the cycle counts of the clock signal CLK provided when an IP block is in an active state. That is, the utilization may mean a ratio of the cycle count actually used by the IP block among the total cycle counts of the clock signal CLK (clock signal having an operating frequency according to the DVFS table 350) generated by the CMU 210. As the workload of the IP block increases, the cycle count actually used by the IP block among the total cycle counts of the clock signal CLK may increase, and thus the utilization may increase.

As described above, the first group GROUP_1 may exhibit characteristics of relatively large dynamic power consumption and relatively small static power consumption, or may be a group representing a characteristic of the lowest static power consumption. (On the other hand, the second group GROUP_2 may exhibit characteristics of relatively small dynamic power consumption and relatively large static power consumption.) The integrated circuit 10 according to an implementation may perform an efficient DVFS operation by first changing the operating frequency based on the power characteristic of the IP block before the utilization increases or decreases according to an increase or decrease of the workload and reaches a threshold utilization.

In some implementations, in a group (e.g., the first group GROUP_1) exhibiting the characteristic of low static power consumption, power consumption may be reduced by securing more idle periods. In other words, the first group GROUP_1 consumes relatively low power in the idle period, and thus the total power consumption may be reduced by increasing the operating frequency at an earlier time and securing more idle periods. More specifically, an IP block with lower static power consumption may generate more operating frequency change periods capable of reducing the total power consumption through an early increase in the operating frequency. Therefore, when the utilization of arbitrary IP block included in the first group GROUP_1 increases (e.g., when workload increases), power consumption may be reduced by preemptively increasing the operating frequency currently provided to the arbitrary IP block before the utilization increases to a threshold utilization for the increase in the operating frequency. In some implementations, power consumption may be further reduced by performing a power gating operation on the secured idle period.

In an implementation, a first IP block included in the first group GROUP_1 may receive a sixteenth operating frequency (or sixteenth voltage-frequency level) L15, and the utilization according to the workload may be 60%. As the workload of the first IP block increases, the utilization may increase, and a first threshold utilization cu_1 at the sixteenth operating frequency level L15 for providing a higher operating frequency as the workload increases may be, for example, 90%. In this regard, the DVFS controller 120 may reduce power consumption by preemptively (e.g., at a faster time) providing a higher operating frequency without waiting until the utilization of the first IP block increases to the first threshold utilization cu_1. For example, the DVFS controller 120 may provide the fifteenth operating frequency L14 to the first IP block before the utilization of the first IP block increases to the first threshold utilization cu_1. As described above, operating a lower utilization by providing a higher operating frequency may be more advantageous in terms of power consumption (as described above, this is due to the low static power consumption of the IP block). In another implementation, a second IP block included in the first group GROUP_1 may receive the fifteenth operating frequency L14, and the utilization according to the workload may be 50%. As the workload of the second IP block increases, the utilization may increase, and a second threshold utilization cu_2 for providing a higher operating frequency may be, for example, 80%. In this regard, the DVFS controller 120 may reduce power consumption by providing a higher operating frequency (e.g., a fourteenth operating frequency L13) before the utilization of the second IP block increases to the second threshold utilization cu_2.

In some implementations, when the power consumption may not be reduced even though the operating frequency increases at the faster time, e.g., before the utilization of an IP block increases to a corresponding threshold utilization, the DVFS controller 120 may maintain the current operating frequency without an increase in the operating frequency. In an implementation, a third IP block included in the first group GROUP_1 may receive a seventeenth operating frequency L16, and the utilization according to the workload may be 70%. A third threshold utilization cu_3 for providing a higher operating frequency due to an increase in a utilization of the third IP block may be, for example, 90%. In this regard, increasing the operating frequency before the utilization of the third IP block increases to the third threshold utilization cu_3 may increase the power consumption, and accordingly the DVFS controller 120 may maintain the current operating frequency (the seventeenth operating frequency L16) without the increase in the operating frequency.

That is, the DVFS controller 120 may determine whether to increase the operating frequency based on the DVFS table 350 to which power characteristics are reflected. The DVFS controller 120 may predict power consumption when increasing the operating frequency by referring to the DVFS table 350, and may compare the predicted power consumption with the current power consumption to determine whether to increase the operating frequency. Therefore, the DVFS controller 120 may increase the operating frequency when the predicted power consumption according to the increase in the operating frequency is less than or equal to the power consumption at the current operating frequency, that is, when the power consumption decreases. The DVFS controller 120 may preemptively increase the operating frequency of the IP block to a new operating frequency, wherein the new operating frequency is within a frequency range in which a predicted power consumption based on the new operating frequency is less than or equal to a power consumption based on a current operating frequency and the utilization of the IP block.

In some implementations, the DVFS controller 120 may provide an operating frequency as high as possible within a range in which the predicted power consumption decreases according to the increase in the operating frequency. For example, the current utilization at the sixteenth operating frequency L15 of the IP block included in the first group GROUP_1 may be 60%, and the DVFS controller 120 may provide a higher operating frequency (e.g., the thirteenth operating frequency L12 or the fourteenth operating frequency L13) than the fifteenth operating frequency L14 in order to reduce power consumption as the utilization increases. Power consumption may be reduced and simultaneously performance may be further improved, by increasing the operating frequency directly to a higher operating frequency rather than increasing the operating frequency in stages, and fast reactivity may be ensured by reducing the overhead according to a frequency change. Such a DVFS operation may be more advantageous in a situation where workload is continuously increasing.

Conversely, in some implementations, even when the utilization decreases according to a decrease in the workload of the IP block, the DVFS controller 120 may maintain the current operating frequency without directly decreasing the operating frequency. As described above, operating at a low utilization by providing a higher operating frequency may be more advantageous in terms of power consumption, and thus the DVFS controller 120 may maintain the current operating frequency. That is, the DVFS controller 120 may predict power consumption when decreasing the operating frequency by referring to the DVFS table 350, and may compare the predicted power consumption with the current power consumption to determine whether to decrease the operating frequency. The DVFS controller 120 may maintain the current operating frequency until the predicted power consumption due to the decrease in the operating frequency is less than the current power consumption at the current operating frequency. In response to that the predicted power consumption associated with a lower operating frequency is less than the current power consumption, the DVFS controller 120 may decrease the operating frequency of a corresponding IP block.

On the other hand, in some implementations, in a group (e.g., the second group GROUP_2) exhibiting a low dynamic power consumption characteristic, power consumption may be reduced by securing more active periods. In other words, the second group GROUP_2 consumes relatively low power during an operation period, and thus the total power consumption may be reduced by increasing the operation frequency as late as possible and securing more operation periods. Therefore, when the utilization of arbitrary IP block included in the second group (GROUP_2) increases (e.g., when a workload increases), power consumption may be reduced by increasing the operating frequency currently provided to the IP block as late as possible.

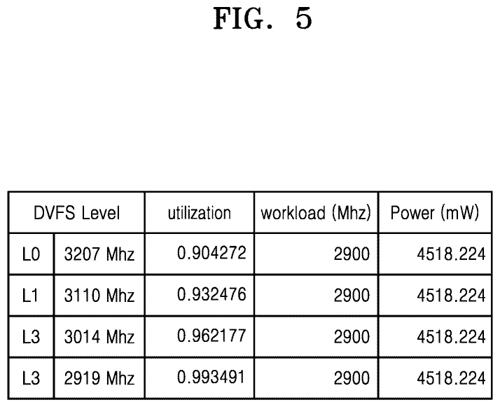

FIG. 5 is a diagram for describing an example of a DVFS operation according to an implementation.

Referring to FIG. 5, the DVFS controller 120 may provide an IP block with a higher operating frequency among a plurality of operating frequencies having the same power consumption. For example, power consumption according to an operating frequency provided to the IP block under any workload (e.g., when the same workload is processed) may appear as shown. Even when the same workload is processed, first to fourth operating frequencies L0 to L3 may have the same power consumption (this phenomenon may be more evident in a group with low static power consumption (e.g., the first group GROUP_1). When the operating frequency increases as a utilization increases at a fifth operating frequency L4, the DVFS controller 120 may directly increase the operating frequency to the first operating frequency L0 instead of increasing the operating frequency to the fourth operating frequency L3.

That is, the DVFS controller 120 may provide, to the IP block, a higher (or highest) operating frequency among a plurality of operating frequencies consuming the same power. Through this, the integrated circuit 10 and/or the device 100 may be advantageous in terms of performance by integrating and simplifying operating frequency changes without unnecessarily proceeding operating frequency changes in stages. The integrated circuit 10 and/or the device 100 may reduce overhead generated when changing the operating frequency, and a timing condition required for a frequency change (switching) may be also mitigated so that a timing margin may be secured. In addition, faster reactivity may be secured when the workload increases rapidly.

In addition, the integrated circuit 10 and/or the device 100 may secure more idle periods by providing a higher operating frequency, and may further reduce power consumption by performing a power gating operation on idle periods, and accordingly heat generation may be reduced.

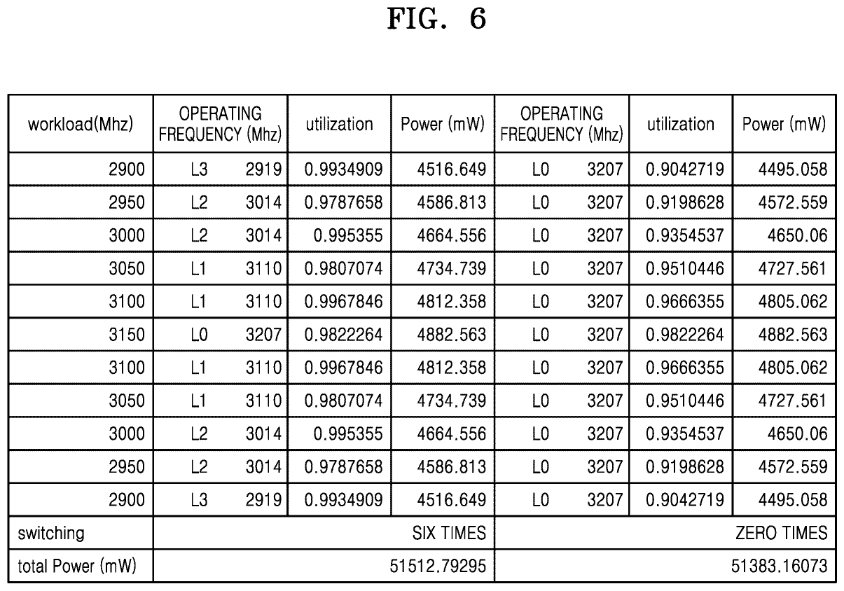

FIG. 6 is a diagram for describing a DVFS operation according to an implementation.

FIG. 6 illustrates an example of a change in an operating frequency of a comparative example according to an increase or decrease in a workload and a change in the operating frequency according to an implementation. The DVFS controller 120 according to an implementation may reduce or minimize an unnecessary frequency change operation by directly increasing the operating frequency to the first operating frequency L0 according to the increase in the workload (utilization), and further reduce power consumption.

More specifically, the comparative example changes the operating frequency when the utilization reaches a threshold utilization, and thus a total of six frequency change (switching) operations are performed. In contrast, an implementation of the present disclosure may not perform the unnecessary frequency change operation by quickly providing a high operating frequency, even when the utilization does not increase to the threshold utilization of each operating frequency level, and may further reduce power consumption by securing an idle period (e.g., increasing a percentage of an idle period). In addition, even when the utilization decreases according to a decrease in the workload, the comparative example performs the frequency change operation that reduces the operating frequency when the utilization reaches the threshold utilization. In contrast, the implementation of the present disclosure may not perform the unnecessary frequency change operation by maintaining a high operating frequency, even when the utilization decreases, and likewise, may reduce power consumption by securing the idle period.

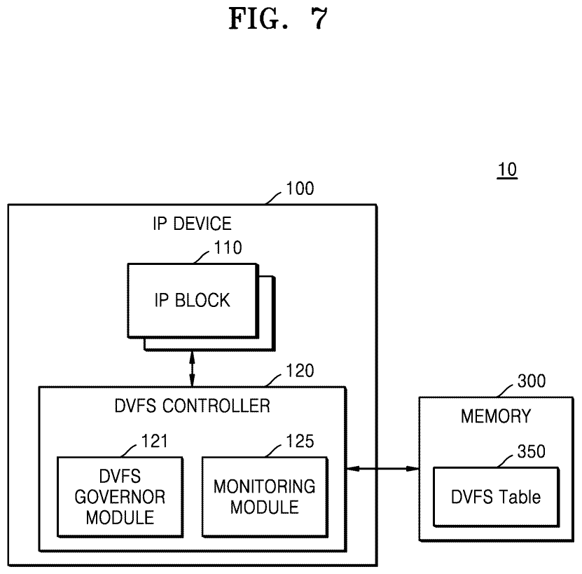

FIG. 7 is a block diagram for describing update of the DVFS table 350 according to an implementation.

Referring to FIG. 7, the DVFS controller 120 may include the DVFS governor module 121 and a monitoring module 125. Descriptions of the components of FIG. 7 redundant with those of FIGS. 1 and 2 are omitted.

The monitoring module 125 may collect the overall operation states (mainly, states of the plurality of IP blocks 110) inside the integrated circuit 10, may generate update information, and provide the update information to the DVFS governor module 121. In some implementations, the monitoring module 125 may generate aging information by checking usage time of the plurality of IP blocks 110, and the monitoring module 125 may measure a degree of deterioration of each of the plurality of IP blocks 110. For example, the monitoring module 125 may generate the update information based on an amount of threshold voltage change, an amount of timing change, operating temperature, power consumption according to an operating voltage and operating frequency, aging information, etc. of each of the plurality of IP blocks 110. The power characteristics of the IP blocks 110 (or chips) may be changed due to deterioration, etc., and the monitoring module 125 may generate the update information by detecting the performance or characteristics of each of the plurality of IP blocks 110 that change in real time. That is, for example, the update information may include the changed static power consumption and dynamic power consumption of the IP block 110. The DVFS governor module 121 may modify the DVFS table 350 stored in the memory 300, based on the update information.

In other words, the DVFS controller 120 may update states of the plurality of IP blocks 110 through the monitoring module 125, and when the characteristics of the IP block 110 (e.g., dynamic power consumption, static power consumption, and/or total power consumption) change due to deterioration of a device, may more precisely perform a DVFS operation by reflecting changes and modifying the DVFS table 350.

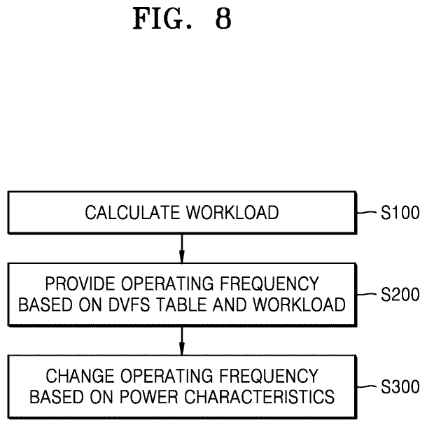

FIG. 8 is a flowchart illustrating a method of operating the integrated circuit 10, according to an implementation.

Referring to FIG. 8, the method of operating the integrated circuit 10 may include operations S100, S200, and S300. In operation S100, the DVFS controller 120 may calculate a workload of work performed by the plurality of IP blocks 110 to provide an appropriate dynamic voltage and dynamic frequency to the IP blocks 110.

In operation S200, the DVFS controller 120 may provide the operating frequency to the IP blocks 110, based on the DVFS table 350 stored in the memory 300 and the calculated workload. The DVFS controller 120 may obtain the operating voltage and/or operating frequency to be provided to the IP blocks 110 from the DVFS table 350 according to the calculated workload. The DVFS table 350 may include a plurality of groups classified according to power characteristics of the IP blocks (or chips). For example, the plurality of groups may be grouped according to the magnitude of dynamic power consumption and/or the magnitude of static power consumption. That is, the DVFS controller 120 may perform a more efficient DVFS operation by referring to the DVFS table 350 including the plurality of groups classified based on dynamic power consumption and/or static power consumption characteristics of the IP blocks.

In operation S300, the DVFS controller 120 may change the operating frequency provided to the IP blocks, based on the DVFS table 350, to the power characteristics are reflected. A utilization may fluctuate as the workload of the IP blocks increases or decreases, and even when the changed utilization does not reach a threshold utilization for changing the operating frequency, the DVFS controller 120 may secure a margin in terms of timing for a frequency change and reduce power consumption by previously changing the operating frequency based on the power characteristic of the IP block.

The integrated circuit 10 according to an implementation may operate more efficiently by performing the DVFS operation according to the corresponding power characteristic of each IP block, and may improve the performance of the integrated circuit 10 and/or the device 100.

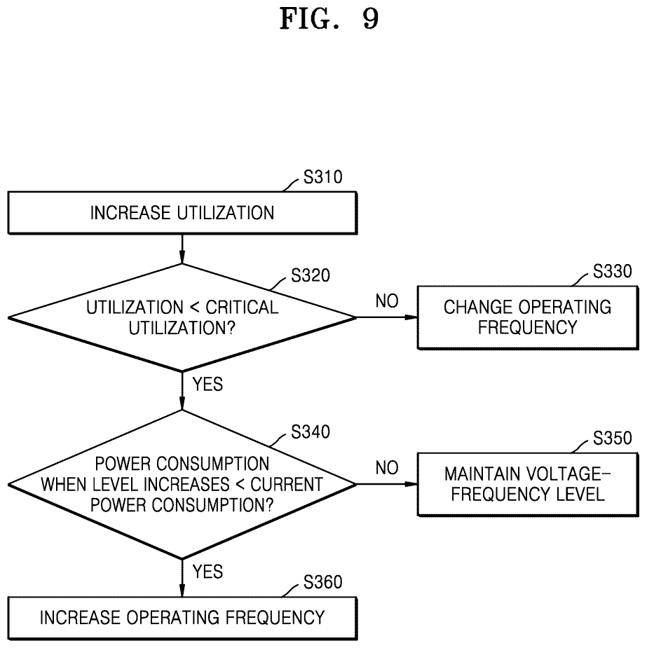

FIG. 9 is a flowchart illustrating a method of operating an integrated circuit, according to an implementation.

Referring to FIG. 9, in operation S310, a utilization may increase according to an increase in a workload of an IP block. In operation S320, the DVFS controller 120 may determine whether the utilization is less than a threshold utilization. When the utilization of the IP block is greater than or equal to the threshold utilization (No in operation S320), because a change in an operating frequency according to the workload increase is necessary, in operation S330, the DVFS controller 120 may change an operating frequency by referring to the DVFS table 350.

In some implementations, even when the utilization is less than the threshold utilization (Yes in operation S320), the DVFS controller 120 may preemptively increase the operating frequency provided to the IP block at a faster time before the utilization increases to the threshold utilization for an increase in the operating frequency. In some implementations, in operation S340, the DVFS controller 120 may determine whether to reduce power consumption according to the increase in the operating frequency, based on the DVFS table 350 to which the power characteristics are reflected. When the power consumption may not be reduced even though the operating frequency increases at the faster time (e.g., when predicted power consumption due to the increase in the operating frequency is greater than the current power consumption) (No in operation S340), the DVFS controller 120 may maintain the current operating frequency without the increase in the operating frequency in operation S350. On the other hand, when power consumption may be reduced by increasing the operating frequency at a faster time (e.g., when the predicted power consumption due to the increase in the operating frequency is less than the current power consumption) (Yes in operation S340), the DVFS controller 120 may reduce power consumption by providing a higher operating frequency in operation S360. In some implementations, the DVFS controller 120 may provide the highest operating frequency within a range in which the predicted power consumption according to the increase in the operating frequency decreases. In addition, in some implementations, the DVFS controller 120 may provide the IP block with a higher (or highest) operating frequency among a plurality of operating frequencies consuming the same power.

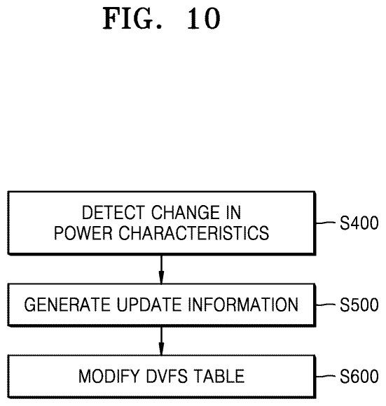

FIG. 10 is a flowchart illustrating a method of updating the DVFS table 350, according to an implementation.

Referring to FIG. 8, the DVFS controller 120 may perform operations S400, S500, and S600 to update the DVFS table 350. In operation S400, the monitoring module 125 may detect a change in a power characteristics of the IP blocks 110. The power characteristic of the IP blocks 110 (or chips) may be changed due to deterioration, etc., and the monitoring module 125 may detect the change in the power characteristic, based on an amount of threshold voltage change, an amount of timing change, operating temperature, power consumption, according to an operating voltage and operating frequency, aging information, etc. In operation S500, the monitoring module 125 may generate updated information indicating the change in the power characteristic of the IP blocks 110. In operation S600, the DVFS governor module 121 may modify the DVFS table 350 based on the update information received from the monitoring module 125.

That is, the DVFS controller 120 may update a state of each of the plurality of IP blocks 110 to reflect the state in the DVFS table 350, and may perform a more precise DVFS operation.

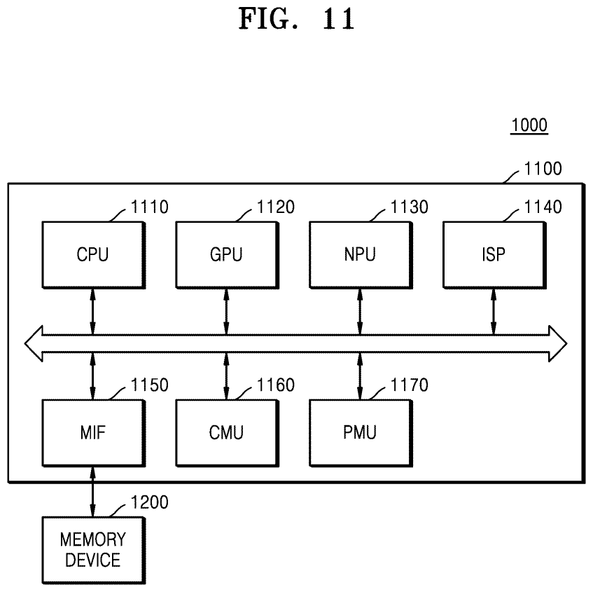

FIG. 11 is a block diagram illustrating a system 1000 according to an implementation.

Referring to FIG. 11, the system 1000 may be implemented as a mobile phone, a smartphone, tablet computer, a PDA, an EDA, a digital still camera, a digital video camera, a PMP, a PND, a handheld game console, or a handheld device such as an e-book.

The system 1000 may include an SoC 1100 and a memory device 1200. The SoC 1100 may include a CPU 1110, a GPU 1120, an NPU 1130, an ISP 1140, a memory interface (MIF) 1150, a CMU 1160, and a PMU 1170. The CPU 1110, the GPU 1120, the NPU 1130, and the ISP 1140 may be referred to as a master IP device, and the MIF 1150 may be referred to as a slave IP device. At least one of the CPU 1110, the GPU 1120, the NPU 1130, or the ISP 1140 may be an implementation example of the device 100 or the plurality of IP blocks 110 described above with reference to FIGS. 1 to 10. Accordingly, at least one of the CPU 1110, the GPU 1120, the NPU 1130, or the ISP 1140 may include a DVFS controller that performs a DVFS operation according to an implementation. The DVFS controller included in at least one of the CPU 1110, the GPU 1120, the NPU 1130, or the ISP 1140 may control the CMU 1160 or the PMU 1170, and the CPU 1110, the GPU 1120, the NPU 1130, and the ISP 1140 may process instructions by receiving the clock signal CLK from the CMU 1160 and receiving a power voltage from the PMU 1170. The DVFS controller included in at least one of the CPU 1110, the GPU 1120, the NPU 1130, or the ISP 1140 may manage power more efficiently (by providing an operating frequency according to a power characteristic) by performing a DVFS operation on the corresponding unit or processor according to the corresponding power characteristic, and may improve the performance of a device or an IP block.

The CPU 1110 may process or execute instructions and/or data stored in the memory device 1200 in response to a clock signal generated by the CMU 1160 (that is, according to an operating frequency controlled by the DVFS controller).

The GPU 1120 may obtain image data stored in the memory device 1200 in response to the clock signal generated by the CMU 1160 (that is, according to the operating frequency controlled by the DVFS controller). The GPU 1120 may generate data for an image output on a display device from image data provided from the MIF 1150, or may encode the image data.

The NPU 1130 may refer to an arbitrary device executing a machine learning model. The NPU 1130 may be a hardware block designed to execute the machine learning model. The machine learning model may be a model based on an artificial neural network, a decision tree, a support vector machine, a regression analysis, a Bayesian network, a genetic algorithm, etc. The artificial neural network may include, as a non-limiting example, a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, and a classification network.

The ISP 1140 may perform a signal processing operation on raw data received from an image sensor located outside the SoC 1100 and generate digital data having improved image quality.

The MIF 1150 may provide an interface for the memory device 1200 located outside the SoC 1100. The memory device 1200 may be DRAM, phase-change random access memory (PRAM), resistive random access memory (ReRAM), or flash memory.

The CMU 1160 may generate the clock signal and provide the clock signal to components of the SoC 1100. The CMU 1160 may include a clock generation device such as a phase locked loop (PLL), a delayed locked loop (DLL), a crystal, etc. The PMU 1170 may convert external power into internal power and supply the internal power to the components of the SoC 1100.

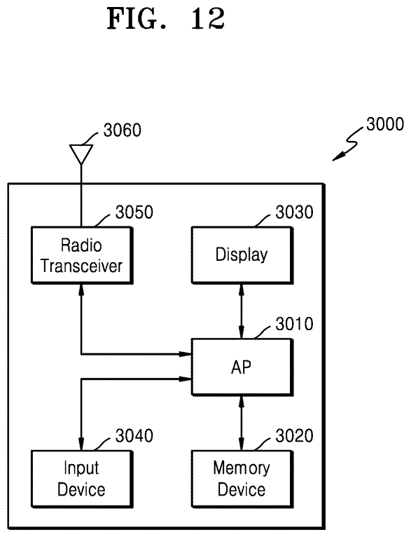

FIG. 12 is a block diagram illustrating a communication device 3000 including an AP 3010 according to an implementation.

Referring to FIG. 12, the communication device 3000 may include the AP 3010, a memory device 3020, a display 3030, an input device 3040, and a radio transceiver 3050. The AP 3010 may be an implementation example of the integrated circuit 10 described above with reference to FIGS. 1 to 10.

The radio transceiver 3050 may transceive a radio signal through an antenna 3060. For example, the radio transceiver 3050 may change the radio signal received through the antenna 3060 into a signal that may be processed by the AP 3010.

Accordingly, the AP 3010 may process the radio signal output from the radio transceiver 3050 and transmit the processed radio signal to the display 3030. In addition, the radio transceiver 3250 may change the signal output from the AP 3010 into a radio signal and output the radio signal to an external device through the antenna 3060.

The input device 3040 is a device capable of inputting a control signal for controlling an operation of the AP 3010 or data to be processed by the AP 3010, and may be implemented as a pointing device such as a touch pad and a computer mouse, a keypad, or a keyboard.

In some implementations, the AP 3010 may include the DVFS controller 120 according to an implementation. As described above with reference to FIGS. 1 to 10, the DVFS controller 120 may control an operating frequency to be provided to each IP block, based on the DVFS table 350 reflecting the power characteristic of each IP block. The DVFS controller 120 may efficiently manage power by changing the operating frequency at a faster time according to the power characteristic of each IP block and providing the operating frequency to each IP block, and may improve the performance of the AP 3010.

Although not shown in FIG. 12, a CMU providing clock signals to various components provided in the communication device 3000 and a PMU providing power voltages may be further included. The CMU may output a clock signal having a frequency adjusted by the control of the DVFS controller 120, and the PMU may output a power voltage having a magnitude adjusted by the control of the DVFS controller 120.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. An integrated circuit comprising:
a plurality of intellectual property (IP) blocks;
a memory configured to store a dynamic voltage and frequency scaling (DVFS) table, the DVFS table including operating voltages and operating frequencies that are classified into a plurality of groups based on power characteristics of the plurality of IP blocks, wherein the operating voltages and the operating frequencies correspond to workloads; and
a DVFS controller configured to calculate the workload of each of the plurality of IP blocks and control, based on the DVFS table and the calculated workload, an operating frequency provided to each of the plurality of IP blocks,
wherein the DVFS controller is configured to change the operating frequency of an IP block of the plurality of IP blocks based on the power characteristics of the IP block before a utilization of the IP block reaches a threshold utilization, wherein the utilization is a ratio at which the IP block uses a clock signal having the operating frequency.

2. The integrated circuit of claim 1, wherein the power characteristics include information indicative of at least one of dynamic power consumption or static power consumption.

3. The integrated circuit of claim 2, wherein
the plurality of groups include a first group and a second group, and
the static power consumption of corresponding IP blocks in the first group is less than the static power consumption of corresponding IP blocks in the second group.

4. The integrated circuit of claim 3, wherein the dynamic power consumption of corresponding IP blocks in the second group is less than the dynamic power consumption of corresponding IP blocks in the first group.

5. The integrated circuit of claim 3, wherein the DVFS controller is configured to increase the operating frequency of the IP block before the utilization of the IP block in the first group increases to the threshold utilization.

6. The integrated circuit of claim 5, wherein the DVFS controller is configured to increase the operating frequency of the IP block to a new operating frequency, wherein the new operating frequency is within a frequency range in which a predicted power consumption based on the new operating frequency is less than or equal to a power consumption based on a current operating frequency and the utilization of the IP block.

7. The integrated circuit of claim 3, wherein the DVFS controller is configured to, in response to a decrease in the utilization of the IP block in the first group, maintain a current operating frequency of the IP block until a predicted power consumption based on a decrease in the operating frequency is less than a power consumption based on the current operating frequency and the utilization.

8. The integrated circuit of claim 1, wherein
at least one of the plurality of groups includes a first operating frequency and a second operating frequency, wherein the first and second operating frequencies have the same power consumption, and the first operating frequency is greater than the second operating frequency, and
the DVFS controller is configured to increase the operating frequency to the first operating frequency in response to the utilization increasing at a current operating frequency, wherein the current operating frequency is lower than the first operating frequency and the second operating frequency.

9. The integrated circuit of claim 8, wherein the DVFS controller is configured to, irrespective of a decrease in the utilization, maintain the operating frequency at the first operating frequency until a predicted power consumption based on a decrease in the operating frequency is less than a power consumption based on the first operating frequency and the utilization.

10. The integrated circuit of claim 5, wherein the DVFS controller is configured to perform power gating with respect to an idle period secured through an increase in the operating frequency.

11. The integrated circuit of claim 1, wherein
the DVFS controller further includes a monitor configured to detect a change in the power characteristics of the plurality of IP blocks to generate update information, and the DVFS controller is configured to modify the DVFS table stored in the memory based on the update information.

12. A method of operating an integrated circuit, the method comprising:
calculating a workload of each of a plurality of intellectual property (IP) blocks;
providing an operating frequency to each of the plurality of IP blocks, based on the calculated workload and a dynamic voltage and frequency scaling (DVFS) table, the DVFS table having operating voltages and operating frequencies that are classified into a plurality of groups based on power characteristics of the plurality of IP blocks; and
changing the operating frequency of an IP block of the plurality of IP blocks based on the power characteristics of the IP block before a utilization of the IP block reaches a threshold utilization, wherein the utilization is a ratio at which the IP block uses a clock signal having the operating frequency.

13. The method of claim 12, wherein the plurality of groups of the DVFS table include a first group and a second group, and a static power consumption of corresponding IP blocks in the first group is less than a static power consumption of corresponding IP blocks in the second group.

14. The method of claim 13, wherein changing the operating frequency comprises: increasing the operating frequency of the IP block before the utilization of the IP block in the first group increases to the threshold utilization.

15. The method of claim 14, wherein increasing the operating frequency comprises:
increasing the operating frequency to a new operating frequency within a frequency range in which a predicted power consumption based on the new operating frequency is less than or equal to a power consumption based on a current operating frequency and the utilization.

16. The method of claim 12, wherein at least one of the plurality of groups includes a first operating frequency and a second operating frequency, wherein the first and second operating frequencies have the same power consumption, and the first operating frequency is greater than the second operating frequency, and
wherein changing the operating frequency comprises:
increasing the operating frequency to the first operating frequency in response to the utilization increasing at a current operating frequency, wherein the current operating frequency is lower than the first operating frequency and the second operating frequency.

17. The method of claim 12, further comprising:
generating update information by detecting a change in the power characteristics of the plurality of IP blocks; and
modifying the DVFS table based on the update information.

18. An integrated circuit comprising:
a plurality of intellectual property (IP) blocks;
a memory configured to store a dynamic voltage and frequency scaling (DVFS) table, the DVS table having operating voltages and operating frequencies that are classified into a plurality of groups based on power characteristics of the plurality of IP blocks, wherein the operating voltages and the operating frequencies correspond to workloads;
a DVFS controller configured to calculate the workload of each of the IP blocks; and generate, based on the calculated workload and the DVFS table, a voltage control signal and a frequency control signal for respectively controlling the operating voltage and the operating frequency that are provided to each of the plurality of IP blocks;
a power management unit (PMU) configured to adjust a magnitude of a power voltage provided to each of the plurality of IP blocks in response to the voltage control signal; and
a clock management unit (CMU) configured to adjust a frequency of a clock signal provided to each of the plurality of IP blocks in response to the frequency control signal,
wherein the DVFS controller is configured to change the operating frequency of an IP block of the plurality of IP blocks based on the power characteristics of the IP block before a utilization of the IP block reaches a threshold utilization, wherein the utilization is a ratio at which the IP block uses a clock signal having the operating frequency.

19. The integrated circuit of claim 18, wherein the DVFS controller is configured to generate the voltage control signal and the frequency control signal to cause the operating frequency of the IP block to increase to a new operating frequency before the utilization of the IP block increases to the threshold utilization, wherein the new operating frequency is within a frequency range in which a predicted power consumption based on the new operating frequency is less than or equal to a power consumption based on a current operating frequency and the utilization of the IP block.

20. The integrated circuit of claim 18, wherein the DVFS controller is configured to, in response to a decrease of the utilization of the IP block, generate the voltage control signal and the frequency control signal to maintain a current operating frequency of the IP block until a predicted power consumption based on a decrease in the operating frequency is less than a power consumption based on the current operating frequency and the utilization of the IP block.
